(19) United States
(12) Patent Application Publication
(10) Pub. No.: US 2020/0171391 A1
(43) Pub. Date: Jun. 4, 2020

(54) Bracket Fantasy Sports With Community League

(71) Applicant: Charles Taylor, Stockbridge, GA (US)

(72) Inventor: Charles Taylor, Stockbridge, GA (US)

(21) Appl. No.: 16/700,904

(22) Filed: Dec. 2, 2019

Related U.S. Application Data
(63) Continuation-in-part of application No. 15/594,797, filed on May 15, 2017, now abandoned.
(60) Provisional application No. 62/336,716, filed on May 15, 2016.

(51) Int. Cl. A63F 13/828; A63F 13/35

(52) U.S. Cl. CPC A63F 13/828; A63F 13/35

(57) ABSTRACT

Contestants submit names for their fantasy football teams and a lineup with names associated with field positions. For each of n weeks of the football season all fantasy teams are allocated to one of two leagues; only undefeated teams are allocated to a bracket league and all remaining teams are allocated to a community league. Teams in the bracket league are paired for one-on-one competitions for that week. After each week each team is assigned a score in dependence on performance of live football players corresponding to the names in the lineups. For each bracket league team pair there is a winner and a loser; the loser goes to the community league and the winner is retained in the bracket league for the next week. Prizes are awarded in both the bracket league and in the community league for various weeks, including an overall bracket league winner in the final of the n weeks.

### PRIORITY CLAIM

This application is a continuation-in-part of U.S. patent application Ser. No. 15/594,797 filed on May 15, 2017, and further claims priority through that parent application to provisional U.S. patent application Ser. No. 62/336,716 filed on May 15, 2016.

### TECHNOLOGICAL HELD

The described invention relates to online fantasy (American) football in which contestants select actual professional football players, for example playing in the National Football League® (NFL®), to populate their respective virtual teams in which the performance of the virtual teams against one another within the fantasy football contests depends upon the selected actual/live players' performance while playing football on-field.

### BACKGROUND

As used herein unless specifically noted otherwise, football refers to American football. Online fantasy sports are known in the art. In general the underlying sport is a team sport for which there are actual teams pitted against one another in live on-field play. More specifically, fantasy football contestants operate from the position of a team manager and populate their fantasy team by ‘drafting’ virtual renditions of the live football players that currently play on the actual teams that compete on-field in the underlying team sport. Performance of the fantasy football team is directly related to the on-field performance of the actual players who are ‘drafted’ to be on that fantasy team and selected for play by the fantasy football contestant/fantasy team manager. For example, if actual running back player AB scores a 6-point touchdown on-field in American football during a given week, any fantasy football contestant/team manager who drafted a virtual rendition of player AB onto his/her team and selected player AB for its line-up to play for that current week would receive a certain number of fantasy points to reflect that touchdown which the actual player AB scored in live on-field play. These basics closely follow the earliest fantasy sports contests which date to about 1962, which at that time appear to have been restricted to in-person fantasy sports leagues.

Different from those early in-person fantasy sports leagues, online fantasy sports leagues currently allow different fantasy team managers to select the same actual player for their respective fantasy teams and further have a more complex scoring system such as awarding a prescribed number of points for every X passing or rushing yards an actual player accumulates during on-field play in the current football week. These factors enable a very large increase in the number of different fantasy teams any given fantasy league can handle. More complex scoring rules that account for player performance that does not necessarily result in points in the live on-field football games mean the fantasy play of these multiple fantasy football teams can be more precisely distinguished from one another, thus minimizing the number of tie scores there may occur in the fantasy football league which can now accommodate a very large number of fantasy teams that all compete against one another in a given week. But this competition against hundreds or even thousands of other fantasy teams is a radical departure from the one-on-one competitions by which winners are chosen among the actual football teams in live on-field play.

Embodiments of these teachings retain some of the advantages that online fantasy football offers over the originating in-person fantasy sports leagues while remaining more true to how winners are chosen in the live on-field play in which the actual football teams engage on the field of play. Namely, these teachings retain the ability for a given fantasy league to host thousands of fantasy teams while avoiding one-versus-many competitions to determine the winning fantasy team. Because online fantasy sports has become a multi-billion dollar business this is not a small adaptation in practice; there are a wide variety of supporting businesses to aid in fantasy team drafting which utilize statistical and/or heuristic analysis, and sometimes even artificial intelligence, in order to increase a fantasy contestant's odds of winning. Changing how winning is defined radically alters how one engages in any competition, and fantasy football is no exception. Another advantage of these teaching is they significantly reduce much of the hidden advantages of computer-aided fantasy team drafting over human cognitive drafting of players for fantasy teams, hidden advantages that are inherent in the use of one-versus-many competitions to define winners as is conventional in the most popular fantasy football leagues.

### SUMMARY

According to a first aspect of these teachings there is a method comprising: prior to a start of n weeks, each corresponding to a different week of a football season where n is an integer greater than two, receive from respective contestants an entry fee and a fantasy football team comprising a list of names where each name corresponds to a live football player; and thereafter:
for each respective week of the n weeks except a final week of the n weeks:
   A. for each of the fantasy football teams that are undefeated for the season and none others, pair the undefeated fantasy football teams for one-on-one competitions in a bracket league;
   B. designate a winner and a loser from each of the one-on-one competitions given a scoring regimen that assigns to at least some of the names points that reflect performance of the corresponding live football player during the corresponding week of the football season;
   C. prior to a start of a next subsequent one of the n weeks, add to the community league each of the respective week's designated losers and retain in the bracket league only each of the respective week's designated winners;
for at least some of the n weeks:
   D. rank order all of the fantasy football teams in the community league using the scoring regimen or an alternate regimen that assigns to at least some of the names points that reflect performance of the corresponding live football player during the corresponding week of the football season;
   E. tangibly award a valuable prize to the contestant associated with the fantasy football team in the community league that is highest in the ranked order;
for the final week of the n weeks:
   F. use the scoring regimen to designate a bracket league winner and a bracket league loser from amongst only two fantasy football teams remaining in the bracket league; and
   G. tangibly award a respective more valuable and less valuable prize to the respective contestants associated with the respective bracket league winner and bracket league loser.

According to a second aspect of these teachings there is/are one or more servers comprising at least one processor and at least one memory storing a program of executable computer instructions; wherein the at least one processor is configured with the at least one memory and the program of executable instructions to cause the one or more servers to perform the actions described immediately above with the exception of tangibly awarding the various prizes which may or may not be done by other means.

According to a third aspect of these teachings there is/are one or more computer readable memories storing a program of computer instructions that when executed by one or more processors of one or more electronic devices causes the electronic devices to perform the actions described above with the exception of tangibly awarding the various prizes which may or may not be done by other means.

In a particular embodiment n is at least 15, while D and E are performed for at least n−1 of the n weeks. In one implementation of this embodiment a valuable prize is awarded to each of the winners designated at B for at least half of the n weeks, and these valuable prizes increase in value for each subsequent ones of the n weeks. In another implementation of this embodiment the actions are performed with exactly 2ⁿ fantasy football teams that comprise a first bracket, and the actions are further performed during the same football season with further fantasy football teams arranged in at least one parallel second bracket such that each of the at least one second brackets has a maximum of 2ⁿ of the further fantasy football teams.

In another particular embodiment a tie score within any one-on-one competition is not possible within the scoring regimen. In another particular embodiment the list comprises a roster submitted by each of the respective contestants and the at least some of the names consist of a lineup selected by the respective contestant, where for each respective contestant the lineup is a subset of the roster. In a preferred embodiment each contestant is enabled to change his/her fantasy team's lineup for each of the n weeks.

In a further particular embodiment there is additionally a virtual gauntlet room in which fantasy football teams from the bracket league and/or from the community league engage in one-on-one competition against one another, in parallel with these same fantasy football teams playing in the bracket league and/or in the community league. In this embodiment, results of the virtual gauntlet room competitions have no effect on designating any winner or loser in the bracket league or in the community league.

In a very particular embodiment the more valuable prize is a monetary prize of at least $1 million.

According to a fourth aspect of these teachings there is a method of operating a fantasy football game in which scores of fantasy teams are determined based upon on-field performance of live football players corresponding to player names on the respective fantasy teams. In this aspect the improvement comprises collecting only one entry fee per fantasy team for participation in the fantasy football game across multiple weeks, where the fantasy football game comprises a bracket league and a community league. Further in this aspect, in each of the multiple weeks a) only those fantasy teams that are undefeated in the fantasy football game are allocated to the bracket league, and one-versus-one competitions are operated amongst pairs of the fantasy teams that are allocated to the bracket league; b) all of the fantasy teams that are not allocated to the bracket league are allocated to the community league, and a one-versus-many competition is operated amongst the fantasy teams that are allocated to the community league. Further in this aspect a valuable prize is transferred to a contestant associated with the fantasy team that remains undefeated in the fantasy football game following a final one of the multiple weeks.

According to a fifth aspect of these teachings there is/are one or more servers comprising at least one processor and at least one memory storing a program of executable computer instructions; wherein the at least one processor is configured with the at least one memory and the program of executable instructions to cause the one or more servers to perform the actions described above for the fourth aspect with the exception of transferring the valuable prize which may or may not be done by other means.

According to a sixth aspect of these teachings there is/are one or more computer readable memories storing a program of computer instructions that when executed by one or more processors of one or more electronic devices causes the electronic devices to perform the actions described above for the fourth aspect with the exception of transferring the valuable prize which may or may not be done by other means.

In various embodiments of the fourth/fifth/sixth aspects the multiple weeks number 16; the fantasy football game is limited to no more than 2¹⁶ fantasy teams, there are multiple of the fantasy football games operating in parallel, and both the one-versus-one competitions and the one-versus-many competitions are amongst only fantasy teams within the same fantasy football game.

In other embodiments of the fourth/fifth/sixth aspects, for at least half of the multiple weeks a valuable prize is transferred to the contestant associated with the fantasy football team that prevailed in its respective one-versus-one competition for the respective week, and a value of the valuable prize transferred to the contestant associated with the fantasy football team that prevailed in its respective one-versus-one competition increases in each subsequent one of the at least half the multiple weeks.

In further embodiments of the fourth/fifth/sixth aspects, for each of the multiple weeks except a first of the multiple weeks, a lesser valuable prize is transferred to the contestant associated with the fantasy team that prevailed in the one-versus-many competition for the respective week. Further implementations are characterized in that, for each of the multiple weeks except the first of the multiple weeks, a lesser valuable prize is transferred to at least the contestants associated with multiple ones of the fantasy teams that scored highest in the one-versus-many competition for the respective week.

In these fourth/fifth/sixth embodiments, collecting the entry fee per fantasy team is implemented via networked computers; and a) allocating to the bracket league, b) operating the one-versus-one competitions, c) allocating to the community league, and d) operating the one-versus-many competitions are implemented via at least one server. In a specific implementation of this, only for the one-versus-one competitions for which the scores of the pair of fantasy teams are tied, the at least one server implements a tie-breaker rule that designates only one of the pair of fantasy teams as the winning fantasy team of the respective one-versus-one competition.

Similar as noted above for the first/second/third aspects, in a specific embodiment of this fourth/fifth/sixth aspect the valuable prize transferred to the contestant associated with the fantasy team that remains undefeated in the fantasy football game following the final one of the multiple weeks is no less than one million US dollars. As detailed below, this amount is independent of reductions due to mandatory withholding by tax authorities prior to distribution to that particular winning contestant.

These and other aspects and embodiments of the invention are detailed further below with particularity.

### BRIEF DESCRIPTION OF THE DRAWINGS

FIG. 1A is a schematic diagram conceptually illustrating one bracket of a bracket league of fantasy football that handles a maximum of 2ⁿ=65,536 fantasy teams in one-on-one play across n=16 weekly intervals of play and a community league in which those defeated in bracket play are automatically entered, according to an example embodiment of these teachings.

FIG. 1B is a table enumerating for each of 16 weekly intervals the fantasy teams that are defeated in the bracket league of FIG. 1A moving to the community league, according to an example embodiment.

FIG. 2, illustrated as FIGS. 2A-B, is a process flow diagram illustrating certain aspects of these teachings from the perspective of a central server or group of cloud-based servers that implement the fantasy football teachings described herein.

FIG. 3 is a process flow diagram similar to FIG. 2 illustrating certain other aspects of these teachings.

FIG. 4 is a high level schematic block diagram showing an environment in which these teachings may be practiced and certain components of a server suitable for practicing these teachings.

### DETAILED DESCRIPTION

Unless otherwise specified herein, the term football refers to American football.

In general for fantasy sports the performance of the individual fantasy sports teams for a given interval (for example, one week of the football season) reflect the on-field performance of actual/live players of the sport, during the given interval, that the fantasy team ‘manager’ selects to play on his/her fantasy team during that given interval. In this regard each fantasy team is populated with the names of actual/live players of the sport. There is a pre-defined scoring regimen by which such on-field performance translates to points for the fantasy football team. An example fantasy football scoring regimen for offense and for defense is presented at respective Tables 1 and 2 below.

TABLE 1
Fantasy Team Scoring based on on-
field offensive player performance

| | | Fantasy |
|---|---|---|
| | | team |
| | On-field player performance | points |
| Passing | Touchdown via pass thrown | 4 |
| | Every 25 passing yards thrown | 1 |
| | 2-point conversion thrown | 2 |
| | Interception thrown | −2 |
| Rushing | Touchdown rushing | 6 |
| | Every 10 rushing yards | 1 |
| | 2-point conversion rushing | 2 |
| Receiving | Touchdown via pass received | 6 |
| | Every 10 pass reception yards | 1 |
| | 2-point conversion pass received | 2 |
| Miscellaneous Offense | Kickoff return touchdown | 6 |
| | Punt return touchdown | 6 |
| | Fumble recovered for touchdown | 6 |
| | Fumble turnover | −2 |
| Kicking | Field goal made (50+ yards) | 5 |
| | Field goal made (40-49 yards) | 4 |
| | Field goal made (0-39 yards) | 3 |
| | Point after touchdown made | 1 |
| | Field goal missed (any distance) | −1 |

TABLE 2
Fantasy Team Scoring based on on-field
defensive player performance.

| | | Fantasy |
|---|---|---|
| | | team |
| | On-field player performance | points |
| Defensive Touchdowns | Kickoff returned for touchdown | 6 |
| | Punt returned for touchdown | 6 |
| | Interception returned for touchdown | 6 |
| | Fumble returned for touchdown | 6 |
| Miscellaneous Defense | Blocked punt or field goal returned | 6 |
| | for touchdown | |
| | Interception | 2 |
| | Fumble recovered | 2 |
| | Blocked punt, point after touchdown | 2 |
| | or field goal | |
| | Safety | 2 |
| | Sack | 1 |

For example, if Fantasy Team Q names quarterback Joe Smith to play in week 4 and during week 4 the actual/live Joe Smith throws for a total of 287 yards including 2 touchdown passes and one interception, Joe Smith's on-field performance will add a total of 17 points to Fantasy Team Q's score for week 4 according to Table 1 above (11 points for passing yards thrown, 8 points for touchdowns thrown and −2 points for one interception thrown). Fantasy Team Q's total score for week 4 may be computed by adding the fantasy point contribution from all players named to Fantasy Team Q's starting lineup for week 4 corresponding to those respective players' on-field performance during week 4.

The most popular online fantasy football regimens typically do not allow for team scoring contributions from individual defensive players. Embodiments of these teachings can include defensive fantasy football team points from individual defensive team players' on-field performance in the weekly team totals, while other embodiments may arrive at the weekly team totals using a conventional ‘team defense’ approach in which the fantasy team ‘manager’ selects his/her entire defensive line from one of several actual football team defensive lineup options with no option to select individual fantasy defensive players from different actual football teams. Other embodiments may employ a hybrid, for example the fantasy team manager or contestant selects one from among several defensive line options yet has the further option to replace one or two or a few fantasy players from that selected lineup with individually selected defensive fantasy players. The defensive fantasy points of the Table 2 example above can be used to translate the on-field performance of actual/live defensive players to fantasy points regardless of whether the fantasy defensive players are selected individually, as a lineup, or according to a hybrid approach such as the example mentioned above.

To avoid confusion between the actual on-field players of the sport and their virtual counterparts on a given fantasy team, the on-field players are referred to herein as actual or live football players, while the members of the fantasy team will be referred to as names of the players. Each fantasy sports team will be populated with names of players selected by the fantasy team manager/contestant. Each name is associated with one or a limited few positions on the fantasy team, so for example one name may be associated with the position of wide receiver while another is associated with quarterback and still another is associated with running back. There may be multiple names associated with one position on a fantasy team, for example three quarterbacks and two running backs, in order for the fantasy team manager/contestant flexibility to adjust for late changes in his/her assessment of on-field players when setting his/her fantasy lineup for the next fantasy competition. Each unique fantasy team is associated with a fantasy team manager/contestant but any given fantasy team manager/contestant may be associated with multiple fantasy teams, even in the same bracket, so long as he/she pays the required entry fee for each fantasy team.

In some embodiments there is a maximum number of names the fantasy team manager/contestant may submit for its roster to populate a fantasy team, and at least prior to the start of the season (prior to the initial week of play) the fantasy team manager/contestant submits a lineup of those names that will ‘play’ for the fantasy team for the coming week/interval. Names on the fantasy team roster that are not also in the lineup are considered ‘benched’ and do not contribute to the fantasy team's score while they are benched; only names in the lineup contribute to the fantasy team's score in any given week. Where the fantasy team manager/contestant can select names of individual defensive team players, in one embodiment the lineup can include names for one defensive lineman (tackle or end) position, one flex-position defensive lineman/linebacker position, one linebacker position, and 2 flex-position cornerback/safety positions. In some embodiments the fantasy team manager/contestant has the option of setting a new lineup for each week and if no new lineup is set the previous week's lineup is automatically the lineup for the coming week. In some embodiments employing team defense as opposed to individual defensive players or hybrid defensive lines, the fantasy team defense will correspond to the actual players for the given week, recognizing that any week-to-week changes in the fantasy team's defensive line will correspond exactly to changes made on-field by the actual football team's manager without any further input by the fantasy team manager/contestant.

As will be detailed below, for bracket league play the fantasy teams are paired against one another in one-on-one competitions for each week and each fantasy team in the bracket league engages in exactly one such one-on-one competition per week. There may be occasional exceptions to this pairing whereby a fantasy team in bracket league play gets a ‘bye’ week in which they do not compete during that week, for example if there are an odd-number of fantasy teams at the start of the initial week 1. Teams in the bracket league that get a ‘bye’ week automatically advance within the bracket league for the next subsequent week. In an embodiment every fantasy team selected to get a ‘bye’ week is selected at random.

For the case in which the fantasy team managers/contestants can change their respective team's lineup week to week, in an embodiment at least the managers/contestants associated with the fantasy teams competing in the bracket league are enabled to view at least the most recently played lineup of their fantasy team opponent for the upcoming week, and in some embodiments these fantasy team managers/contestants are enabled to view all lineups used at any time in the bracket league for the current season by any fantasy team. This makes additional information on their upcoming opponent available to the fantasy team managers/contestants so each fantasy team manager/contestant in bracket league play can more particularly tailor their lineup to win their fantasy team's upcoming one-on-one bracket league contest. Fantasy team managers/contestants are allowed to make week-to-week changes to their fantasy team lineups, for which there is a deadline to submit prior to the start of any on-field play of the actual teams for the week. So for example assuming professional football is scheduled for on-field play between Thursday evening and the following Monday evening for any given weekly interval of the season, the lineup submission deadline for any given week may be midnight on the Wednesday prior to the Thursday which begins that given week, or in another example it may be 3 pm eastern time on the Thursday of that given week.

If a fantasy team manager/contestant does not submit a lineup by the prescribed deadline, the fantasy team's default lineup is entered automatically. The default lineup may for example be selected by fantasy team managers/contestants when ‘drafting’ their fantasy team, or the default lineup may be that chosen by a given fantasy team manager/contestant for that team's previous week's competition. As with conventional fantasy football, the ‘drafting’ of fantasy teams and/or lineups may be subject to a salary cap per fantasy team.

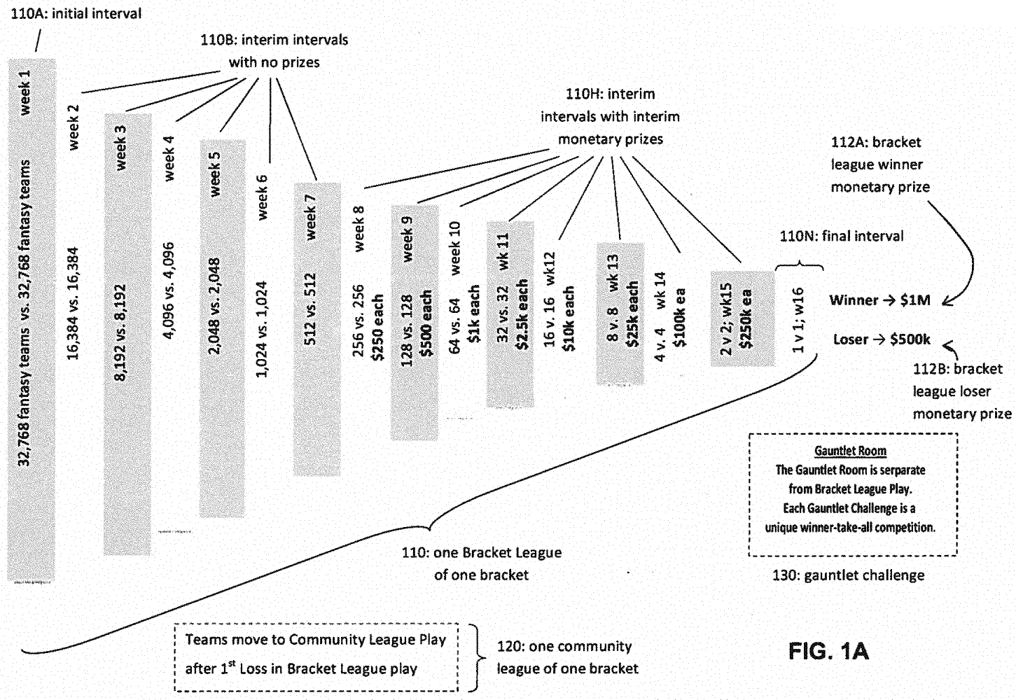

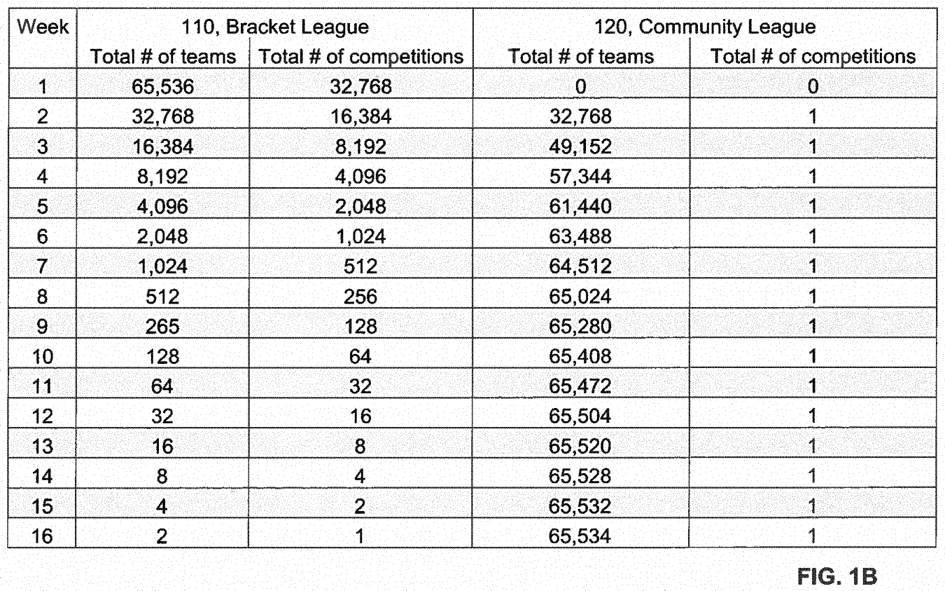

Now having defined the fantasy teams with rosters of names and lineups, as well as how the fantasy team scores are determined in dependence on the on-field performance of the actual/live football players corresponding to the names in the lineup, refer to FIGS. 1A-B for an explanation of the bracket league 110 play and the community league 120 play. In embodiments of these teachings, throughout the season only those fantasy teams that are undefeated will compete in bracket league 110 play as best shown at FIG. 1A, and upon defeat in the bracket league 110 any given fantasy team is automatically moved to community league 120 play for the remainder of the season as will be explained in more detail with reference to FIG. 1B. Team rosters and scoring remain the same for bracket league 110 and community league 120 play, and if the fantasy team manager/contestant is able to change his/her fantasy team's lineup in bracket league 110 play generally he/she will be able to change it in the community league 120 play. However, there are no one-on-one competitions in community league 120 play and thus no single designated opponent for a given fantasy team in the community league 120. Instead the highest score per week among all the fantasy teams in the community league 120 determines the community league winner (or winners) for that week.

Like on-field professional football there are 16 weeks in the example fantasy football season of FIGS. 1A-B, shown chronologically in FIG. 1A as:
an initial interval 110A (week 1);
followed by a few interim intervals with no prizes 110B (weeks 2 through 7);
followed by several interim intervals with prizes 110H (weeks 8 through 15); and
followed by a final interval 110N (week 16).

Because the competitions in the bracket league 110 are each exactly one fantasy team versus exactly one fantasy team (with the exception of bye weeks for certain fantasy teams as noted above for certain embodiments), the bracket league can accommodate no more than 2ⁿ fantasy teams where n is an integer representing the number of intervals/weeks of on-field play. So for the case of n=16, the number of weeks in professional football, the maximum number of fantasy teams for one bracket is 2¹⁶=65,536. If there are more than this maximum number of fantasy team teams signed up to play prior to the start of the on-field football season (or prior to the fantasy team submission deadline which may be somewhat earlier in time), another (second) bracket is created and the excess fantasy teams over 65,536 go into the bracket league of this newly created other/second bracket. Once this other/second bracket is filled any excess fantasy teams over 2*65,536 go into the bracket league of a further (third) bracket, and so forth until all fantasy teams that entered on time are assigned to a bracket league of one specific bracket out of a total of one or more brackets. FIG. 1A illustrates bracket league play for one bracket only, but other second, third, etc. brackets operate identically and in parallel for a given football season.

Assuming the bracket league 110 of FIG. 1A is filled, there are 65,536 unique fantasy teams. In truth it may be not all teams are unique among their roster and/or lineup as even a same manager/contestant may choose to duplicate his/her fantasy team, roster and lineup so long as this is not prohibited by the implementing software or rules. Such duplication makes no difference to the conduct of the fantasy play and so it can be assumed that all fantasy teams are unique without loss of this description's practicality or clarity, During play in week 1 (initial interval 110A) each of the 65,536 teams are undefeated and so every one of them are in the bracket league 110 for week 1. FIG. 1A illustrates 32,768 teams versus 36,768 teams in the bracket league 110 for week 1 (110A). Since team competitions in the bracket league 110 are one-on-one, there are 36,768 one-on-one competitions in week 1. The winning fantasy team of each of these competitions in the bracket league is the fantasy team that outscores its fantasy team opponent for that week. So for example if during week 1 fantasy team #1 competes against fantasy team #2 and wins by a score of 41 to 37, fantasy team #1 is the winner of that bracket league 110 competition during week 1 and would remain in the bracket league 110 for week 2 despite that every other fantasy team in week 1 may score more than 41 fantasy points. In this example fantasy team #2 would move automatically to the community league 120 beginning in week 2 since it is no longer undefeated at the end of week 1. Assuming no tie scores and that no fantasy team that has a ‘bye’ in week 1 (110A), mathematically 36,768 fantasy teams will be winners for week 1 in the bracket league 110 and will thus remain in the bracket league 110 for the start of week 2 while the other 36,768 fantasy teams will be losers for week 1 in the bracket league 110 and will thus automatically move to the community league 120 for the start of week 2. Once a fantasy team is in the community league 120 it cannot return to the bracket league 110 for the remainder of the season.

In bracket league 110 play no pair of competing teams can end with a tie score so there is a rule or set of rules to settle any tied fantasy scores. In one example the rule is that in the event of a tie score the fantasy team with the higher number of points in the final period of play (final quarter for football) is declared the winner, and if this still does not resolve the tie the fantasy team with the higher number of points in the final two quarters of play is declared the winner, and so forth. In this regard the fantasy points based on the actual live players' on-field performance will be accredited to the fantasy team in the same quarter as those points were accumulated by the actual/live players. In a preferred example, in the event of a tie fantasy score the fantasy team that submitted its lineup for the week earlier than its bracket-league competitor for that week is declared to be the winner. In certain embodiments similar tie-breaking rules may be imposed for fantasy play in the community league 120.

This one-on-one competition in the bracket league 110 between undefeated fantasy teams continues throughout all the other interim weeks 110B, 110H. In the FIG. 1A example there are 36,768 one-on-one competitions and an equal number of fantasy team winners in the bracket league 110 for week 1; there are 16,384 one-on-one competitions and an equal number of fantasy team winners in the bracket league 110 for week 2; there are 8,192 one-on-one competitions and an equal number of fantasy team winners in the bracket league 110 for week 3; and so forth where the number of one-on-one competitions and winners in the bracket league 110 halves in each subsequent week. For the initial week 110A and some number of interim weeks 110B sequentially following the initial week 110A, in an embodiment no monetary prizes are awarded to the winners of the bracket league 110 competitions.

Following these there are several consecutive interim intervals/weeks 110H preceding the final interval/week 110N in which prizes are awarded to the manager/contestant of each fantasy team that prevails in its bracket league 110 competition, and as FIG. 1A illustrates the amount of these monetary prizes increases progressively as the respective week 110H is nearer in time to the final interval/week 110N. The manager/ontestant of the prevailing fantasy team in the final week 110N bracket league 110 competition is awarded the largest prize of FIG. 1A, termed a bracket league winner monetary prize 112A. The manager of the non-prevailing fantasy team in the final week 110N of bracket league 110 competition is awarded a smaller prize which FIG. 1A terms a bracket league loser monetary prize 112B; in the FIG. 1A embodiment this is the only fantasy team that is a losing team in the bracket league 110 which is awarded a monetary prize. Monetary awards shown by example at FIG. 1A for the bracket league are reproduced below at Table 3. [note: due to the column headings Table 3 does not specifically reflect the $500,000 monetary prize that FIG. 1 shows as being awarded to the losing team 112B in the final week 16.]

TABLE 3
Bracket League monetary awards.

| Week | # of winning fantasy teams | Pre-team monetary prize |
|---|---|---|
| 8 | 256 | $250 |
| 9 | 128 | $500 |
| 10 | 64 | $1,000 |
| 11 | 32 | $2,500 |
| 12 | 16 | $10,000 |
| 13 | 8 | $25,000 |
| 14 | 4 | $100,000 |
| 15 | 2 | $250,000 |
| 16 | 1 | $1,000,000 |

Monetary prizes in the community league 120 are preferably less generous but may operate on a similarly progressively-increasing basis for each week in which a monetary prize is awarded. The weeks in which monetary prizes are awarded for the community league 120 may or may not match those interim weeks 110H of the bracket league 110 for which monetary prizes are awarded, but for simplicity of this example assume that they are. In this non-limiting example there are a total of 100 fantasy teams that are designated winners in the community league 120 for each week in which community league 120 monetary prizes are awarded. Tie fantasy scores may be resolved as described above for the bracket league so there are no tie scores in the community league 120 when a monetary prize is at stake. Alternatively the community league prizes may be split evenly among fantasy teams having a tied score so for example using Table 4 below if two teams are tied for first place they will each split the $25,000 top prize and also split the $10,000 second place prize.

In this example the monetary prizes for the community league 120 are paid out only in weeks 8 through 16, and the amounts paid out are identical in each of those weeks as opposed to progressively increasing amounts as with the bracket league example. Fantasy teams in the community league 120 are rank-ordered according to their scores for the given week and in this example the top-ranked 100 fantasy teams are awarded monetary prizes as shown at Table 4 below.

TABLE 4
Community League monetary awards, each
week in which awards are given.

| # of winning fantasy teams | Per-team monetary prize |
|---|---|
| Top scoring/top ranked fantasy team | $25,0000 |
| Next 2-5 scoring/ranked teams | $10,000 each |
| Next 6-10 scoring/ranked teams | $5,000 each |
| Next 11-25 scoring/ranked teams | $2,500 each |
| Next 26-50 scoring/ranked teams | $1,000 each |
| Next 51-100 scoring/ranked teams | $500 each |

In some embodiments there is an optional ‘gauntlet room’ 130 which is a venue in which any fantasy team may engage in one-on-one competition with another fantasy team. This is strictly voluntary from week to week and any fantasy team, whether in the bracket league 110 or the community league 120, can play in the gauntlet room 130 one or multiple times in any given week, all in parallel and with that same fantasy team lineup playing in the bracket or community league. In one embodiment the managers/contestants may be able to set a different lineup for their gauntlet room play, or for each of multiple gauntlet room competitions in which the same fantasy team competes, different from their same-week lineup in the bracket league or the community league. Essentially managers/contestants volunteer their team for the gauntlet room 130, the implementing software pairs the gauntlet room teams or the managers/contestants mutually agree to a one-on-one competition between their respective teams/lineups, and they each pay a separate gauntlet room entry fee for each gauntlet room competition in which their fantasy team engages. There may be a fixed minimum fee or bet to which managers/contestants can add to when both competing fantasy team managers/contestants agree, and this addition may in some embodiments be in the manner of onscreen raising and calling ‘bids’ to increase the amount of the gauntlet room entry fee from both competing fantasy team managers/contestants. The manager/contestant of the winning fantasy team of a gauntlet room competition is returned his/her gauntlet room entry fee plus the corresponding entry fee paid by the competing fantasy team's manager/contestant, less a cut for the gauntlet room administrator such as 5% for example. In this regard the gauntlet room 130 is a winner-take-all proposition for the competing fantasy teams. Gauntlet room 130 participation and results have no effect on winning or not, or any monetary award amount, in the bracket league 110 nor in the community league 120.

Unlike other online fantasy sports football regimens, in embodiments of these teachings there are two parallel leagues 110, 120 and a losing fantasy team in the bracket league 110 is not out for the season because they are automatically moved to the community league 120 where in a preferred embodiment there are a higher number of opportunities to win, albeit at lower average monetary prize values for at least the late-season weeks per the examples at Tables 3 and 4 above. Each fantasy team manager/contestant pays a single entry fee for the season and there is no additional fee due to continue fantasy play in the community league 120 after a fantasy team is defeated in one-on-one play within the bracket league 110. Also unlike other online fantasy sports regimens the bracket league 110 offers one-on-one competitions with progressive payouts for repeat winners once the season has progressed to the interim weeks 110H in which monetary prizes are awarded. In the example of FIG. 1A the winner of the largest monetary prize available (the bracket league monetary prize 112A) needs only to defeat 16 other fantasy teams as opposed to other fantasy sports regimens in which each fantasy team competes en masse against all other fantasy teams (for example, 80,000 or more other teams) and the grand prize winner must outscore them all. This is true in both weekly and season-length conventional fantasy football contests; in the former the overall winner has the most points of all fantasy teams competing during that week while in the latter the overall winner is the fantasy team with the highest cumulative points across the entire football season. Further unlike other fantasy sports regimens, in some embodiments of these teachings for the bracket league 110 each fantasy team manager/contestant can see what lineups its upcoming opposing team has played in the past and what lineup its opposing team has set for the current week; that information is simply not useful in conventional fantasy football where the competition is en masse against many other fantasy teams. In this regard the manager/contestant of an individual fantasy football team may plan to use multiple different lineups throughout the season but can select only one per team per week. To play multiple different lineups of a same fantasy team the fantasy team manager/contestant would need to register the same fantasy football team multiple times (that is, enter the same roster of player names on differently registered fantasy teams and pay the entry fee for each such fantasy team) and play the different lineups in the differently-registered fantasy teams in a given week.

FIG. 1B illustrates transitions of the fantasy teams defeated in the bracket league 110 to the community league 120 using the same 2¹⁶=65,536 total number of fantasy teams for the bracket as the above example. As noted above, at the start of week 1 there are 65,536 total fantasy teams and at that time none are undefeated so they all compete in the bracket league 110. During that week 1 there are 36,768 one-on-one competitions in bracket league play and at the end of week 1 there will be 36,768 winning fantasy teams and an equal number of defeated fantasy teams. At the start of week 2, those 36,768 fantasy teams that were defeated in bracket league play during week 1 will compete en masse against each other in the community league 120. Thus in week 2 each of those 36,768 fantasy teams that were defeated in week 1 will compete in the community league 120 against 36,767 other fantasy teams that were defeated in week 1. One-on-one competitions in the bracket league 110 during week 2 will yield an additional 16,384 defeated fantasy teams, which will all move to the community league 120 for competition during week 3 with the original 36,768 defeated fantasy teams for a total of 49,152 fantasy teams competing en masse against one another in the community league during week 3. One-on-one competitions in the bracket league 110 during week 3 will yield an additional 8,192 defeated fantasy teams, which will all move to the community league 120 for competition during week 4 with the 49,152 fantasy teams that were already in the community league for the week 3 competition, for a total of 57,344 fantasy teams competing in the community league 120 during week 4. FIG. 1B shows similar progression throughout the 16-week season; each fantasy team that was defeated in the bracket league during a given week is added to the community league in the subsequent week, to join with all other fantasy teams already in the community league 120. The total number of fantasy teams competing in both the bracket league and the community league is equal to the total number of teams that started in week 1 in bracket league play, in this case 2¹⁶=65,536 total fantasy teams. As the weeks progress the number of fantasy teams in the community league 120 increases by the exact amount of fantasy teams that were defeated in the previous week's bracket league 110. By week 16 there are 65,524 fantasy teams competing in the community league 120, and only two fantasy teams competing in the bracket league 120 since to that point only those two are undefeated in bracket league play.

The rightmost column of FIG. 1B shows that there is one competition per week in the community league 120, where all competing fantasy teams are rank-ordered according to their fantasy score for the purpose of determining prize awards for those interim weeks in which prizes are awarded in the community league 120 (in certain embodiments). The exception is the initial week 1 where no fantasy teams have yet been defeated in the bracket league 110. A fantasy team defeated in the bracket league 110 during a given week will play in the community league 120 during all remaining weeks of the season. This means that every team, no matter how it fares against its competitors, will play in each of 16 weeks for this example. So for example a fantasy team defeated in week 1 will play week 1 in the bracket league 110 and weeks 2-16 in the community league 120 for a total of 16 weeks; a different fantasy team defeated in week 7 will play weeks 1-7 in the bracket league 110 and weeks 8-16 in the community league 120 for a total of 16 weeks; and so forth for each and every one of the originating 65,536 fantasy teams. In an embodiment, monetary prizes may be awarded for the community league 120 during each week, and in a variation of this embodiment for week 1 the fantasy teams that were defeated in the bracket league 110 during week 1 will be rank-ordered and the highest ranked ones of those defeated fantasy teams will be awarded community league prizes. In this variation, essentially those fantasy teams defeated in their one-on-one bracket league 110 competitions during week 1 end up competing, simultaneously, in a one-versus-many community league 120 competition, but those fantasy teams that are defeated in the week 1 bracket league that simultaneous compete in the community league 120 cannot be known until resolution of their one-on-one competitions in the bracket league 110. In this regard this variation operates as an exception to the above-mentioned mathematical result that in each week the total number of fantasy teams competing in the bracket league 110 and in the community league exactly equal the total number of fantasy teams that began the season in that given bracket, but the exception only applies for week 1 with this variation.

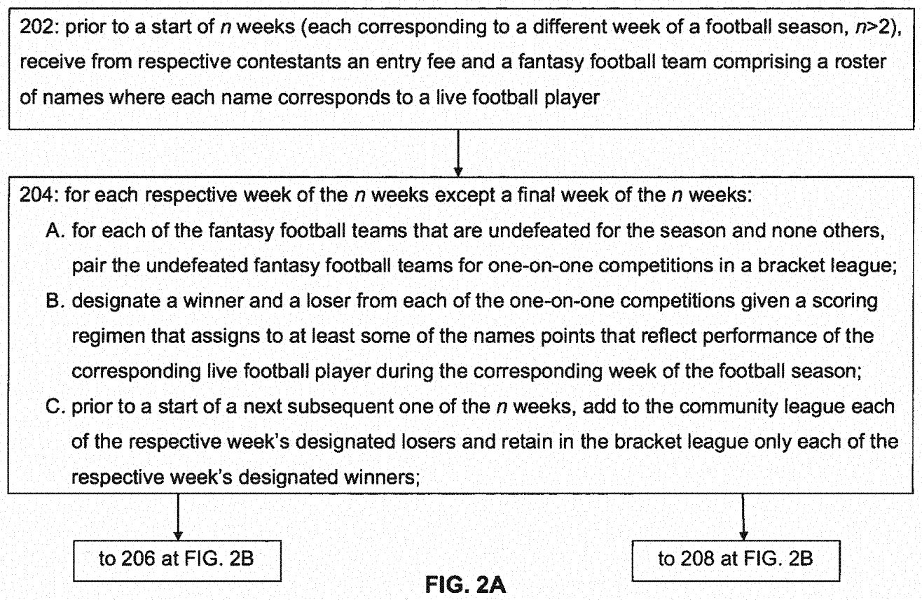

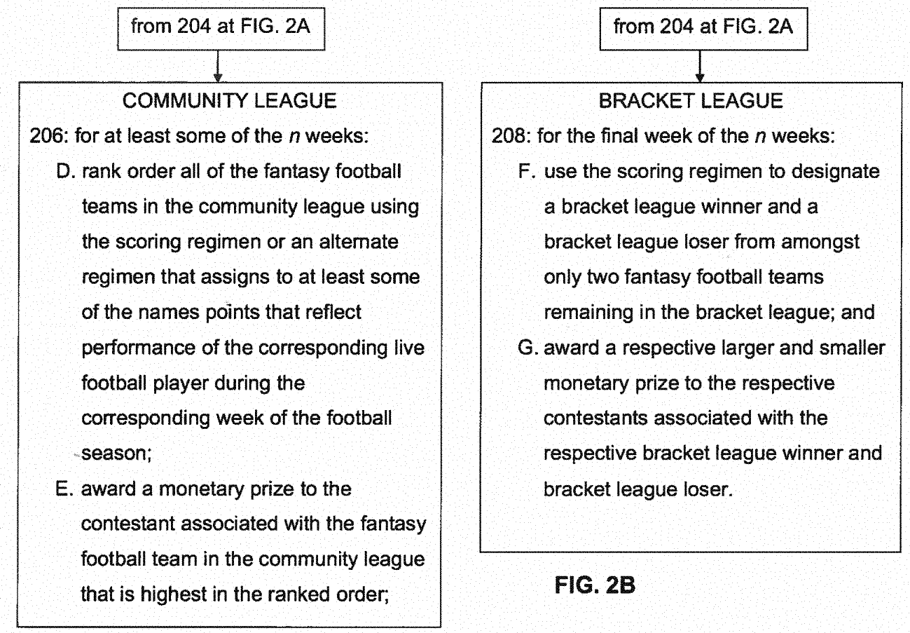

FIG. 2, which is continuous amongst FIGS. 2A and 2B, is a process flow diagram illustrating some aspects of these teachings from the perspective of a computer-implemented method, and also described actions performed by one or more servers executing a stored program of executable computer instructions, as well as actions performed by one or more electronic devices whose processor(s) execute a program of computer instructions stored on one or more computer readable memories, as detailed more fully above. Note that part G at blocks 206 and 208 may be computer implemented, for example when the monetary prizes are automatically credited to the respective contestants' chosen bank accounts via online banking transactions, or they may be implemented in other non-electronic ways such as physically presenting to the contestants bank drafts in the amounts of the monetary prizes at a public event.

Block 202 sets up the fantasy football teams; namely, prior to a start of n weeks, each of the n weeks corresponding to a different week of an American football season where n is an integer greater than two, receive from respective contestants an entry fee and a fantasy football team comprising a roster of names (or at least a lineup of names for the first week) where each name corresponds to a professional American football player. In this regard American football excludes soccer and rugby.

In some embodiments each fantasy team manager/contestant selects a fantasy team roster prior to week 1 and in each week selects a lineup from that roster until teams of the underlying sport begin to be eliminated after which the lineup is selected from among those live players whose teams have not yet been eliminated. A first salary cap may apply for the roster selection, and a second (preferably lower) salary cap may apply for each of the lineups in later weeks that are not restricted to the roster. In other embodiments the fantasy team manager/contestant selects a fantasy team lineup for each of the weeks without regard to any fantasy team roster, and preferably a salary cap applies in these other embodiments to limit the managers'/contestants' options in selecting their lineups. Preferably the implementing software for these other embodiments limits each week's possibilities for selecting these lineups to only those live players that are eligible for on-field play for that respective week.

Block 204 concerns virtual play during all of the n weeks except the (chronologically) final week of the n weeks. Parts A, B and C at block 204 are thus performed for each of those respective weeks. More specifically, part A of block 204 has, for each of the fantasy football teams that are undefeated for the season and for none others, the undefeated fantasy football teams are paired for one-on-one competitions in a bracket league. Part B at block 204 provides that a winner and a loser from each of those one-on-one competitions is designated, and this is done using a scoring regimen that assigns to at least some of the names (for example; names from the lineup that the contestant selects from his/her team roster) points that reflect performance of the corresponding football player during the corresponding week of the American football season. Now with those winners of the one-on-one bracket league competitions determined, prior to a next subsequent one of the n weeks part C of block 204 provides for moving each of the current week's designated losers from part B to a community league and retain in the bracket league only designated winners for that week from part B.

Continuing at the FIG. 2B portion of FIG. 2, block 206 concerns the community league. In this regard parts D and E of block 206 are performed in each of at least some of the n weeks, where ‘some’ refers to more than one, Specifically, for each of those ‘some’ weeks all of the fantasy football teams in the community league are rank ordered and this rank ordering may in some embodiments use the same scoring regimen at part B of block 204 or in other embodiments it may use an alternate regimen that assigns to at least some of the names (e.g., in the lineup) fantasy points that reflect performance of the corresponding live football player during the corresponding week of the American football season. Because the winners in the community league are determined independently of winners of the bracket league it is not necessary that the scoring regimens for these different leagues be identical, though that is the preferred embodiment. At part E of block 206 a monetary prize is awarded to the contestant associated with the fantasy football team in the community league that is highest in the ranked order. In the particular examples above more than only the highest rank-ordered fantasy football team in the community league are awarded monetary prizes at part E of block 206.

Parts F and G of block 208 concerns the bracket league for the final week of the n weeks; note that this same final week was excluded from block 204. Specifically, part F of block 208 uses the scoring regimen to designate a bracket league winner and a bracket league loser from amongst only two fantasy football teams that for this final week are the only fantasy teams remaining in the bracket league. Then at part G of block 208 there is awarded a respective larger and smaller monetary prize to the respective contestants associated with the respective bracket league winner and bracket league loser.

In the non-limiting examples above as applied to a 16-week season of professional (NFL) football, block 204 is performed for weeks 1-15, block 206 is performed for each of weeks 8-16, and block 208 is performed only for week 16. As mentioned above, the weeks of block 206 in which monetary prizes are awarded for the community league may or may not match the weeks in which (interim and final week) monetary prizes are awarded in the bracket league, so for example monetary prizes may be awarded for weeks 8-16 as in the above examples, or for each of weeks 2-16; or even for weeks 1-16 if, as detailed above, the bracket league losers for week 1 are immediately moved to the community league and rank-ordered in that community league for that same week 1 in which they lost in the bracket league.

Whereas FIG. 1A illustrates only one bracket (bracket including one bracket league and one community league, with possibly also the gauntlet room which may or may not be limited to only those teams in one specific bracket), the process flow of FIG. 2 can be implemented in parallel over multiple brackets during a single season. In this case if there are a total of n intervals in the season each bracket would include a maximum of 2″ fantasy football teams. In one example n is an integer at least five. Preferably the bracket league winner monetary prize and the community league monetary prizes are the same across all of the multiple parallel brackets for which the entry fee is the same. Implicit in this is that different brackets can have different monetary award amounts corresponding to the amount of the contestant's entry fee; so for example the bracket(s) with a $150 entry fee per fantasy team may have a highest prize 112A of $1,000,000 as in FIG. 1 while a parallel bracket(s) in the same season may require a $250 entry fee per fantasy team and pay out a highest prize 112A of $2,000,000.

For the above example at Table 3 there are certain interim weeks 110H in which the bracket league winners were awarded a monetary prize. Further, for the above example at Table 4 there are certain interim weeks in which at least one of the fantasy sports teams is selected as a winner of the community league for that respective interim interval week. The fantasy team manager or contestant associated with each of the selected winner or winners of the community league for the respective interim interval/week is awarded a community league interim monetary prize, and the highest monetary prize for the community league is less than the monetary prize awarded to the winner of the bracket league for the final week. The Table 4 example specifically provides for multiple fantasy sports teams being selected as winners in the community league for each of these intervals/weeks, and for the monetary prizes awarded to those multiple fantasy sports team winners in the community league increasing progressively with those teams' respective rank order with respect to one another.

In some embodiments detailed above the fantasy team manager/contestant can select individual defensive players as well as individual offensive players. In some embodiments this fantasy team manager/contestant can set a lineup for his/her the fantasy football team that can include at least a first set of names associated with offensive field positions and in some implementations also a second set of names associated with defensive field positions. From this it follows that the scoring regimen(s) assign points in dependence on performance of the live football players, during the respective week, that match the first set of names and the second set of names of the respective fantasy sports team lineup.

In a preferred embodiment all prizes are monetary prizes but more generally any prize may be a valuable prize for which ownership is transferred to the manager/contestant associated with the respective fantasy team. For the case of monetary (cash) prizes such ownership may be transferred by personally presenting a bank draft in the amount of the monetary prize to the contestant associated with the respective fantasy team, where such bank draft is valid and payable to that contestant or his/her designee. This may be particularly suitable for awarding the prizes at a public event which may be broadcast or video-streamed to the public for marketing or public relations purposes. Ownership of the monetary prize may alternatively be transferred by electronically transferring the value of the monetary prize to a bank or other institutional account (e.g., brokerage, PayPal®, Venmo®, etc.) designated by that contestant for receipt of such monetary prize. [Note that where a third party governmental authority such as a tax agency/authority requires withholding of a portion of the total value before transfer to the contestant, the amount of the monetary prize for which ownership is transferred to the respective contestant is the total of the amount transferred directly to the contestant plus the amount withheld and paid to the third party governmental authority on behalf of that contestant. This is because the withheld amount is a debit payable by the contestant and merely collected by the third party from the person or entity paying the prize.] Currency may also be presented to the contestant or his/her designee as the monetary prize and this presentment itself also represents a transfer of ownership of the currency; this is because currency is a bearer document. In a preferred embodiment the contestants electronically transfer to the game operator an entry fee per fantasy team that each contestant enrolls ($75 or $150 in the above examples), so electronically transferring the monetary prizes to the contestants associated with the winning fantasy teams embodies an efficient symmetry. For non-cash prizes of tangible property such as an automobile or a house, ownership is transferred with title to that property, or for the case of tangible property such as a valuable wristwatch for which there is no title ownership is transferred when the contestant or his/her designee takes possession of the property. For intangible prizes such as exotic vacations, concerts or the theater, ownership is transferred to the contestant when the game operator or its designee provides to that contestant or his/her designee a valid ticket or reservation (electronic or otherwise) in the name of the contestant or his/her designee for airfare, hotel, activity and/or event (e.g., theater, concert, play). In these implementations with non-monetary prizes, the above descriptions relating to relative value of the prizes (higher, lower) is implemented with respect to the monetary value of the prizes regardless whether the prizes themselves are monetary or not. In any case the awarding of the prize is embodied as a tangible transfer of ownership to the winning person/contestant, and this transfer is tangible even if done via an electronic bank transfer since such electronic transfers are readily verifiable and accepted as transfer of ownership.

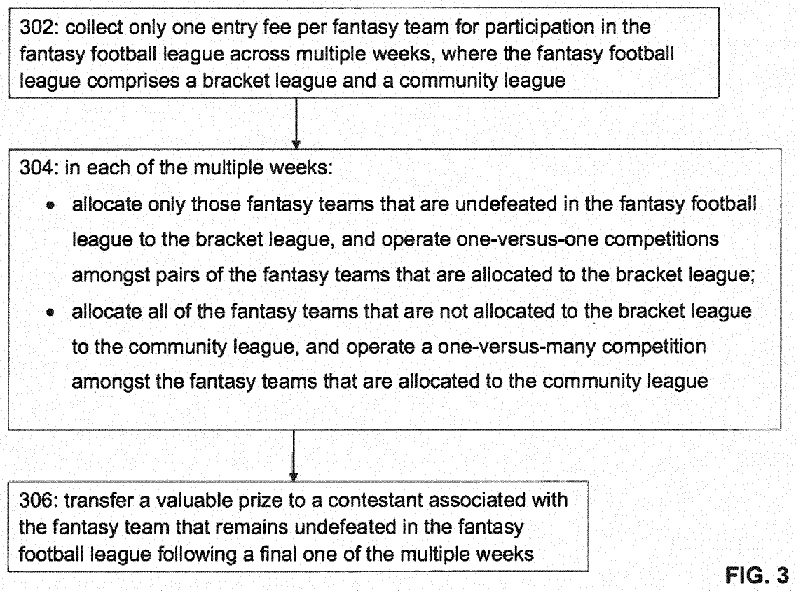

FIG. 3 is another process flow diagram illustrating some other aspects of these teachings, also from the perspective of a computer-implemented method. As with FIG. 2 the actions described for FIG. 3 may be performed by one or more servers executing a stored program of executable computer instructions, as well as actions performed by one or more electronic devices whose processor(s) execute a program of computer instructions stored on one or more computer readable memories, as was already detailed above. FIG. 3 describes operation of a fantasy football league in which scores of fantasy teams are determined based upon on-field performance of live football players corresponding to player names on the respective fantasy teams. In general such fantasy team scoring is known in the art and one example of fantasy team scoring is detailed above for completeness. In the FIG. 3 embodiment the improvement includes at block 302 collecting only one entry fee per fantasy team for participation in the fantasy football league across multiple weeks, where the fantasy football league comprises a bracket league and a community league. Block 304 describes the weekly play. Specifically, in each of the multiple weeks there are allocated only those fantasy teams that are undefeated in the fantasy football league to the bracket league, and one-versus-one competitions are operated amongst pairs of the fantasy teams that are allocated to the bracket league. Further at block 302, all of the fantasy teams that are not allocated to the bracket league are allocated to the community league, and a one-versus-many competition is operated amongst the fantasy teams that are allocated to the community league. Finally for FIG. 3, block 306 describes that a valuable prize is transferred to a contestant associated with the fantasy team that remains undefeated in the fantasy football league following a final one of the multiple weeks. This transference is a tangible transfer of ownership as detailed more fully above.

In one embodiment the multiple weeks of FIG. 3 number 16. In this or another embodiment the fantasy football league is limited to no more than 2¹⁶=65,536 fantasy teams, there are multiple of the fantasy football leagues operating in parallel, and both the one-versus-one competitions and the one-versus-many competitions are amongst only fantasy teams within the same fantasy football league.

In a specific embodiment, for at least half of the multiple weeks a valuable prize is transferred to the contestant associated with the fantasy football team that prevailed in its respective one-versus-one competition for the respective week. In a very specific embodiment, a value of the valuable prize transferred to the contestant associated with the fantasy football team that prevailed in its respective one-versus-one competition increases in each subsequent one of the at least half the multiple weeks.

In another specific embodiment, for each of the multiple weeks except a first of the multiple weeks, a lesser valuable prize is transferred to the contestant associated with the fantasy team that prevailed in the one-versus-many competition for the respective week.

In a still further embodiment of the FIG. 3 aspect, for each of the multiple weeks except the first of the multiple weeks, a lesser valuable prize is transferred to at least the contestants associated with multiple ones of the fantasy teams that scored highest in the one-versus-many competition for the respective week.

In certain implementations, the entry fee per fantasy team collected at block 302 is implemented via networked computers; and the block 204 actions of allocating to the bracket league, operating the one-versus-one competitions, allocating to the community league, and operating the one-versus-many competitions are implemented via at least one server. As detailed more fully above, such a server implementation for the FIG. 3 aspect of these teachings includes a tie-breaker rule. Namely, only for the one-versus-one competitions for which the scores of the pair of fantasy teams are tied, the at least one server implements a tie-breaker rule that designates only one of the pair of fantasy teams as the winning fantasy team of the respective one-versus-one competition.

In a very specific embodiment the valuable prize transferred at block 306 to the contestant associated with the fantasy team that remains undefeated in the fantasy football league following the final one of the multiple weeks is no less than one million US dollars (exclusive of required tax withholding as detailed above).

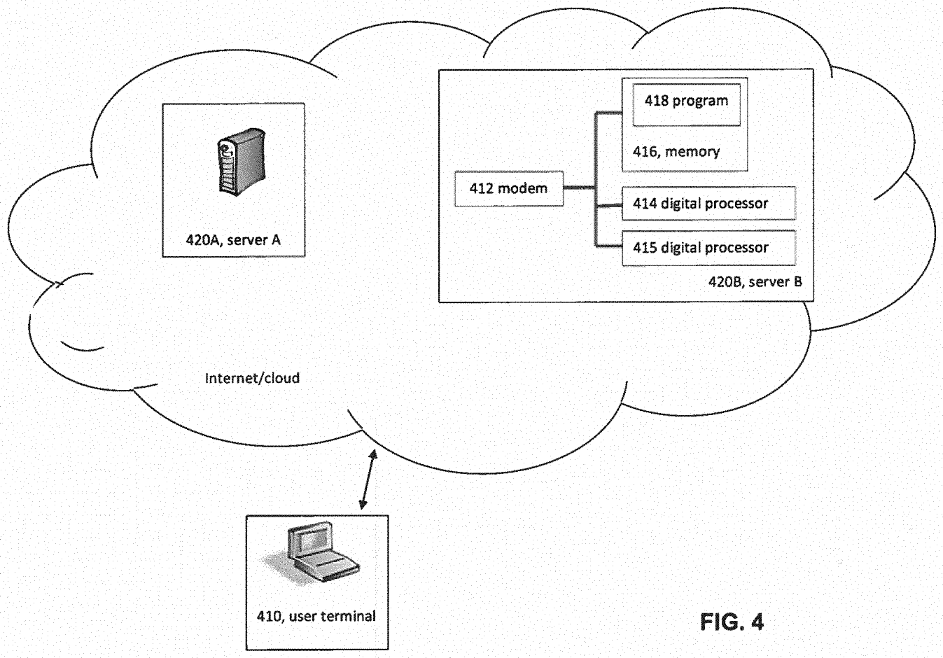

FIG. 4 is a high level diagram illustrating an exemplary environment with cloud-based servers which may embody these teachings, and more specifically a user terminal 410 which may communicate to the cloud (Internet) based servers 420A, 420B the fantasy team manager's/contestant's selections of roster and lineup and at which the fantasy team manager/contestant may receive notifications that he/she is or is not a winner of the various leagues and weeks. While two servers 420A, 420B are shown, these teachings may be embodied on one server or any multiple number of servers in communication with one another over the Internet or other communications network. The servers are functionally similar in relevant part and as shown the server 420B includes a controller, such as a computer or a data processor (DP) 414 (or multiple ones of them), a computer-readable memory medium embodied as a memory (MEM) 416 (or more generally a non-transitory program storage device) that stores a program of executable computer instructions (PROG) 418, and a suitable communications interface 412 such as a modem to the communications network/Internet that will be used for sharing data stored on the different servers' memories, sharing processing power, and accepting inputs and transmitting outputs. In general terms the server 420B can be considered a machine that reads the MEM/non-transitory program storage device and that executes the computer program code or executable program of instructions stored thereon. While the server 420B of FIG. 4 is shown as having one memory 416, in practice each server 420A, 420B may have multiple discrete memory devices and the relevant algorithm(s) and executable instructions/program code may be stored on one or across several such memories, or even across different memories of different servers.

The program 418 is assumed to include program instructions that, when executed by the associated one or more digital processors 414, enable the server/system 420A/B to operate in accordance with exemplary embodiments of this invention. That is, various exemplary embodiments of this invention may be implemented at least in part by computer software executable by the digital processor 414 of the server/system 420A/B; and/or by hardware, or by a combination of software and hardware (and firmware). Note also that one or more of the servers 420B may also include dedicated processors 415. The electrical interconnects/busses between the components at FIG. 4 are conventional and not separately labelled.

The computer readable memory 416 may be of any memory device type suitable to the local technical environment and may be implemented using any suitable data storage technology, such as semiconductor based memory devices, flash memory, magnetic memory devices and systems, optical memory devices and systems, fixed memory and removable memory. The digital processors 414, 415 may be of any type suitable to the local technical environment, and may include one or more of general purpose computers, special purpose computers, microprocessors, digital signal processors, and processors based on a multicore processor architecture, as non-limiting examples. The modem 412 may be of any type suitable to the local technical environment and may be implemented using any suitable communication technology.

Computer readable memory is non-transitory because propagating mediums such as carrier waves are memoryless. More specific examples (a non-exhaustive list) of the computer readable storage medium/memory would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

What is claimed is:

1. A method comprising:
prior to a start of n weeks, each corresponding to a different week of a football season where n is an integer greater than two, receive from respective contestants an entry fee and a fantasy football team comprising a list of names where each name corresponds to a live football player;
for each respective week of the n weeks except a final week of the n weeks:
A. for each of the fantasy football teams that are undefeated for the season and none others, pair the undefeated fantasy football teams for one-on-one competitions in a bracket league;
B. designate a winner and a loser from each of the one-on-one competitions given a scoring regimen that assigns to at least some of the names points that reflect performance of the corresponding live football player during the corresponding week of the football season;
C. prior to a start of a next subsequent one of the n weeks, add to the community league each of the respective week's designated losers and retain in the bracket league only each of the respective week's designated winners;
for at least some of the n weeks:
D. rank order all of the fantasy football teams in the community league using the scoring regimen or an alternate regimen that assigns to at least some of the names points that reflect performance of the corresponding live football player during the corresponding week of the football season;
E. tangibly award a valuable prize to the contestant associated with the fantasy football team in the community league that is highest in the ranked order;
for the final week of the n weeks:
F. use the scoring regimen to designate a bracket league winner and a bracket league loser from amongst only two fantasy football teams remaining in the bracket league; and
G. tangibly award a respective more valuable and less valuable prize to the respective contestants associated with the respective bracket league winner and bracket league loser.

2. The method according to claim 1, where n is at least 15, and where D and E are performed for at least n−1 of the n weeks.

3. The method according to claim 2, wherein for at least half of the n weeks, award a valuable prize to each of the winners designated at B.

4. The method according to claim 3, wherein for all weeks in which the valuable prize is awarded to each of the winners designated at B, said valuable prize increases in value for each subsequent ones of the n weeks.

5. The method according to claim 2 performed with exactly 2ⁿ fantasy football teams that comprise a first bracket, wherein the method according to claim 2 is further performed during the same football season with further fantasy football teams arranged in at least one parallel second bracket such that each of the at least one second brackets has a maximum of 2ⁿ of the further fantasy football teams.

6. The method according to claim 1, wherein the list comprises a roster submitted by each of the respective contestants and the at least some of the names consist of a lineup selected by the respective contestant, where for each respective contestant the lineup is a subset of the roster.

7. The method according to claim 1, wherein the scoring regimen does not allow any tie score for any of the one-on-one competitions.

8. The method according to claim 1, further comprising a virtual gauntlet room in which fantasy football teams from the bracket league and/or from the community league engage in one-on-one competition against one another, in parallel with these same fantasy football teams participating in the bracket league and/or in the community league, and where results of the virtual gauntlet room competitions have no effect on designating any winner or loser in the bracket league or in the community league.

9. A method of operating a fantasy football league in which scores of fantasy teams are determined based upon on-field performance of live football players corresponding to player names on the respective fantasy teams, the improvement comprising:
collecting only one entry fee per fantasy team for participation in the fantasy football league across multiple weeks, where the fantasy football league comprises a bracket league and a community league;
in each of the multiple weeks:
allocating only those fantasy teams that are undefeated in the fantasy football league to the bracket league, and operating one-versus-one competitions amongst pairs of the fantasy teams that are allocated to the bracket league;
allocating all of the fantasy teams that are not allocated to the bracket league to the community league, and operating a one-versus-many competition amongst the fantasy teams that are allocated to the community league; and
transferring a valuable prize to a contestant associated with the fantasy team that remains undefeated in the fantasy football league following a final one of the multiple weeks.

10. The method according to claim 9, wherein the multiple weeks number 16.

11. The method according to claim 10, wherein the fantasy football league is limited to no more than 2¹⁶ fantasy teams, there are multiple of the fantasy football leagues operating in parallel, and both the one-versus-one competitions and the one-versus-many competitions are amongst only fantasy teams within the same fantasy football league.

12. The method according to claim 9, wherein for at least half of the multiple weeks, a valuable prize is transferred to the contestant associated with the fantasy football team that prevailed in its respective one-versus-one competition for the respective week.

13. The method according to claim 12, wherein a value of the valuable prize transferred to the contestant associated with the fantasy football team that prevailed in its respective one-versus-one competition increases in each subsequent one of the at least half the multiple weeks.

14. The method according to claim 12, wherein for each of the multiple weeks except a first of the multiple weeks, transferring a lesser valuable prize to the contestant associated with the fantasy team that prevailed in the one-versus-many competition for the respective week.

15. The method according to claim 9, wherein for each of the multiple weeks except the first of the multiple weeks, a lesser valuable prize is transferred to at least the contestants associated with multiple ones of the fantasy teams that scored highest in the one-versus-many competition for the respective week.

16. The method according to claim 9, wherein:
collecting the entry fee per fantasy team is implemented via networked computers; and
allocating to the bracket league, operating the one-versus-one competitions, allocating to the community league, and operating the one-versus-many competitions are implemented via at least one server.

17. The method according to claim 16, wherein only for the one-versus-one competitions for which the scores of the pair of fantasy teams are tied, the at least one server implements a tie-breaker rule that designates only one of the pair of fantasy teams as the winning fantasy team of the respective one-versus-one competition.

18. The method according to claim 9, wherein the valuable prize transferred to the contestant associated with the fantasy team that remains undefeated in the fantasy football league following the final one of the multiple weeks is no less than one million US dollars.
